(19) United States
(12) Patent Application Publication
(10) Pub. No.: US 2026/0254992 A1
(43) Pub. Date: Aug. 27, 2026

(54) HIERARCHICAL MOTION CODING FOR LEARNING-BASED POINT CLOUD COMPRESSION

(71) Applicant: InterDigital VC Holdings, Inc., Wilmington, DE (US)

(72) Inventors: Junghyun Ahn, New York, NY (US); Jiahao Pang, Plainsboro, NJ (US); Muhammad Asad Lodhi, Highland Park, NJ (US); Dong Tian, Boxborough, MA (US)

(21) Appl. No.: 19/065,395

(22) Filed: Feb. 27, 2025

(51) Int. Cl. H04N 19/597; H04N 19/105; H04N 19/172; H04N 19/587

(52) U.S. Cl. CPC H04N 19/597; H04N 19/105; H04N 19/172; H04N 19/587

(57) ABSTRACT

Some embodiments of a method may include: obtaining a parent level motion feature; generating a first motion feature by upsampling the parent level motion feature; obtaining a reference frame feature; determining a shifted reference frame feature based on the reference frame feature and the first motion feature; decoding a second motion feature from a motion bitstream; generating a current level motion feature by adding the first and the second motion features; generating a predicted feature based on the shifted reference frame feature and the second motion feature; and decoding an inter-predicted point cloud frame based on the predicted feature.

### INCORPORATION BY REFERENCE

The present application incorporates by reference in their entirety the following applications: U.S. Non-Provisional patent application Ser. No. 18/671,759, entitled “MULTI-RESOLUTION MOTION FEATURE FOR DYNAMIC PCC” and filed May 22, 2024 (“759 application”).

### BACKGROUND

The present application is related to point clouds.

### SUMMARY

A first example method in accordance with some embodiments may include: obtaining a parent level motion feature; generating a first motion feature by upsampling the parent level motion feature; obtaining a reference frame feature; determining a shifted reference frame feature based on the reference frame feature and the first motion feature; decoding a second motion feature from a motion bitstream; generating a current level motion feature by adding the first and the second motion features; generating a predicted feature based on the shifted reference frame feature and the second motion feature; and decoding an inter-predicted point cloud frame based on the predicted feature.

For some embodiments of the first example method, decoding the second motion feature includes: obtaining the motion bitstream; arithmetically decoding the motion bitstream; and dequantizing the arithmetically decoded motion bitstream to generate the second motion feature.

For some embodiments of the first example method, obtaining the reference frame includes: obtaining a reference point cloud; and performing a feature extraction of the reference point cloud to generate the reference frame.

For some embodiments of the first example method, upsampling the parent level motion feature includes: unpooling the parent level motion feature; and pruning the unpooled parent level motion feature to generate the first motion feature.

For some embodiments of the first example method, pruning the unpooled parent level motion feature is based on a reference point cloud.

For some embodiments of the first example method, generating the current level motion feature includes: adding the first and the second motion features; and performing a feature enhancement of the added first and second motion features to generate the current level motion feature.

For some embodiments of the first example method, adding the first and the second motion features includes concatenating the first and the second motion features.

For some embodiments of the first example method, generating the predicted feature based on the shifted reference frame feature and the second motion feature includes: concatenating the shifted reference frame feature and the second motion feature to generate a concatenated feature; performing a feature extraction on the concatenated feature to generate an extracted feature; and pruning the extracted feature to generate the predicted feature.

For some embodiments of the first example method, determining the shifted reference frame feature based on the reference frame feature and the first motion feature includes: concatenating the reference frame feature and the first motion feature to generate a concatenated feature; performing a feature extraction on the concatenated feature to generate an extracted feature; and pruning the extracted feature to generate the shifted reference frame feature.

A first example apparatus in accordance with some embodiments may include: a processor; and a memory storing instructions operative, when executed by the processor, to cause the apparatus to: obtain a parent level motion feature; generate a first motion feature by upsampling the parent level motion feature; obtain a reference frame feature; determine a shifted reference frame feature based on the reference frame feature and the first motion feature; decode a second motion feature by obtaining a motion bitstream; generate a current level motion feature by adding the first and the second motion features; generate a predicted feature based on the shifted reference frame feature and the second motion feature; and decode an inter-predicted point cloud frame based on the predicted feature.

A second example method in accordance with some embodiments may include: obtaining a current frame feature; obtaining a parent level motion feature; generating a first motion feature by upsampling the parent level motion feature; obtaining a reference frame feature; determining a shifted reference frame feature based on the reference frame feature and the first motion feature; generating a second motion feature based on the current frame feature and the shifted reference frame feature; generating a current level motion feature by adding the first and the second motion features; generating a predicted feature based on the shifted reference frame feature and the second motion feature; encoding the second motion feature into a motion bitstream; and encoding an inter-predicted point cloud frame based on the predicted feature.

For some embodiments of the second example method, obtaining the current frame feature includes: obtaining a current frame point cloud; and performing a feature extraction on the current frame point cloud to generate the current frame feature.

For some embodiments of the second example method, obtaining the reference frame includes: obtaining a reference point cloud; and performing a feature extraction of the reference point cloud to generate the reference frame.

For some embodiments of the second example method, upsampling the parent level motion feature includes: unpooling the parent level motion feature; and pruning the unpooled parent level motion feature to generate the first motion feature.

For some embodiments of the second example method, pruning the unpooled parent level motion feature is based on a reference point cloud.

For some embodiments of the second example method, generating the current level motion feature includes: adding the first and the second motion features; and performing a feature enhancement of the added first and second motion features to generate the current level motion feature.

For some embodiments of the second example method, adding the first and the second motion features includes concatenating the first and the second motion features.

For some embodiments of the second example method, generating the predicted feature based on the shifted reference frame feature and the second motion feature includes: concatenating the shifted reference frame feature and the second motion feature to generate a concatenated feature; performing a feature extraction on the concatenated feature to generate an extracted feature; and pruning the extracted feature to generate the predicted feature.

For some embodiments of the second example method, determining the shifted reference frame feature based on the reference frame feature and the first motion feature includes: concatenating the reference frame feature and the first motion feature to generate a concatenated feature; performing a feature extraction on the concatenated feature to generate an extracted feature; and pruning the extracted feature to generate the shifted reference frame feature.

For some embodiments of the second example method, encoding the second motion feature into the motion bitstream includes: quantizing the second motion feature; and arithmetically encoding the quantized second motion feature to generate the motion bitstream.

### BRIEF DESCRIPTION OF THE DRAWINGS

The following detailed description will be better understood when read in conjunction with the appended drawings, in which there are shown examples of one or more of the multiple embodiments of the present application. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a schematic illustration showing an example motion feature generation process according to some embodiments.

FIG. 3 is a schematic illustration showing an example motion decoder according to some embodiments.

FIG. 4 is a schematic illustration showing an example predictor generation process according to some embodiments.

FIG. 5 is a schematic illustration showing an example hierarchical motion decoder according to some embodiments.

FIG. 6 is a schematic illustration showing an example motion feature upsampling process according to some embodiments.

FIG. 7 is a schematic illustration showing an example motion feature upsampling process with a reference according to some embodiments.

FIG. 8 is a schematic illustration showing an example motion feature addition process according to some embodiments.

FIG. 9 is a schematic illustration showing an example motion encoder according to some embodiments.

FIG. 10 is a schematic illustration showing an example explicit motion feature encoder according to some embodiments.

FIG. 11 is a schematic illustration showing an example hierarchical motion encoder according to some embodiments.

FIG. 12 is a schematic illustration showing an example explicit hierarchical motion encoder according to some embodiments.

FIG. 13 is a schematic illustration showing an example unified DPCC hierarchical motion encoder according to some embodiments.

FIG. 14 is a schematic illustration showing an example unified DPCC hierarchical motion decoder according to some embodiments.

FIG. 15 is a flowchart illustrating an example learning-based predictive point cloud decoding process according to some embodiments.

FIG. 16 is a flowchart illustrating an example learning-based predictive point cloud encoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present application, certain terminology is used herein for convenience only and should not be considered as limiting such embodiments. In the drawings, the same reference numerals are employed for designating the same elements throughout the several figures and the present description.

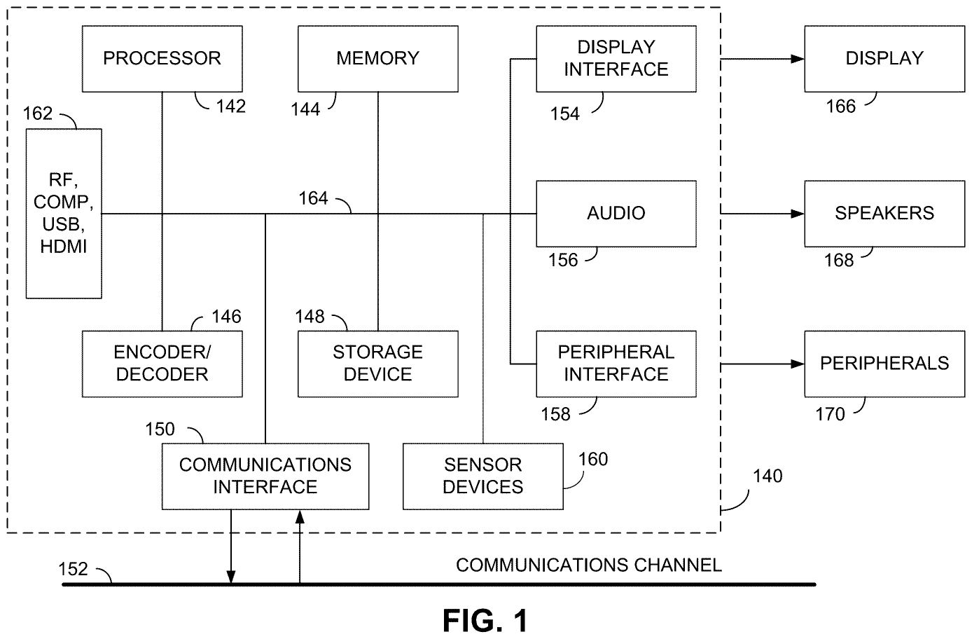

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (I2C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation and understanding of input signals, such as point cloud.

Point cloud is a universal data format across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purpose of world modeling and sensing. Compression of raw point clouds may be used when storage and transmission of the data are used in related scenarios.

Furthermore, point clouds may represent a sequential scan of the same scene, which contains multiple moving objects. They are called dynamic point clouds, while static point clouds may be captured from a static scene or static objects. Dynamic point clouds are typically organized into frames, with different frames being captured at different times. Dynamic point clouds may require the processing and compression to be handled in real-time or with low delay.

### Point Cloud Data Use Cases

The automotive industry and autonomous cars are domains in which point clouds may be used. Autonomous cars are able to “probe” their environment to make good driving decisions based on the reality of their immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes, like the reflectance ratio provided by the LiDAR because this attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer, while in standard TV the viewer may look only at the virtual world in front of the viewer. There are several gradations in the immersivity depending on the freedom of the viewer in the environment. Point cloud are a good format candidate to distribute VR worlds. They may be static or dynamic and are typically of average size, with, e.g., no more than millions of points at a time.

Point clouds also may be used for various purposes, such as culture heritage/buildings in which objects, like statues or buildings, are scanned in 3D to share the spatial configuration of the object without sending or visiting the statues or buildings. Also, point clouds offer a way to ensure preservation of knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology that allows machines to gain knowledge about the 3D world around them, which may be used by the applications discussed above.

3D point cloud data include discrete samples of the surfaces of objects or scenes. A huge number of points may be used to fully represent the real world with point samples. For instance, a typical VR immersive scene contains millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on a point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down-sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

An additional challenge is efficiently interpreting the sparse nature of 3D point clouds compared to regularly arranged 2D pixel samples for an image. To handle this issue, a sparse convolution method may be used, such as the one mentioned in Choy, C. et al., 4D Spatio-Temporal ConvNets: Minkowski Convolutional Neural Networks, IN PROCEEDINGS OF THE IEEE/CVF CONF. ON COMP. VISION AND PATTERN RECOGNITION (CVPR) (2019) (“Choy”). Based on these so-called sparse CNN, learning-based point cloud compression (PCC) is an interesting topic in the computer vision and machine learning communities.

### Motion Estimation for Point Cloud Compression

In general, a sequence of 3D point cloud does not have temporal correspondence between adjacent time frames. This lack of temporal correspondence makes motion analysis and motion compensation processes more challenging comparing to other 3D sequence representation, such as a mesh. For an efficient dynamic point cloud compression (PCC), typically either a motion vector or a motion feature is used as a tool for analyzing and synthesizing motion information. A vector-based approach needs a fine-grained control because each vector points towards a temporally corresponding point or block. On the other hand, feature-based approaches often aggregate features in a down-sampled block level, but careful neural network (NN) layer design is necessary to avoid loss of information during the feature aggregation, motion analysis, or motion compensation steps.

Estimating motion between current and reference frame(s) greatly supports the performance of the point cloud compression (PCC) via inter-coding. For a learning-based PCC, different representations exist for defining the concept of motion, for example, through a motion vector or a motion feature. The application of the motion feature may be more suitable for a learning-based PCC, in the sense that a feature is defined in a higher dimension space, implying complex information within a form of a feature map. However, this complex information needs to be carefully derived into a feature space, to recover efficiently after the compression. In the present application, this problem may be solved with a hierarchical motion coding branch that better encodes and decodes a motion feature. Feature-based inter-coding techniques for learning-based dynamic PCC are described herein.

An implicit inter-coding technique along with residual feature coding was introduced in Akhtar, A., et al., Inter-Frame Compression for Dynamic Point Cloud Geometry Coding, 33 IEEE TRANS. ON IMAGE PROCESSING 584-594 (2024) (“Akhtar”). Unlike traditional inter-coding that takes both current and reference frames for motion estimation, only the reference frame is used to predict the current frame without an explicit motion estimation process. This method aggregates features from the reference frame and generates a predictor feature on the down-sampled coordinate of the current frame. A residual feature between the two down-sampled current and predicted features is entropy coded for the reconstruction. Because the motion information is not explicitly packed in a bitstream, a predictor estimates a predicted feature on the decoder side. This implicit method may be efficient for small and simple motions. However, this method may have problems implicitly conveying complex motion(s) during reconstruction.

On the other hand, a feature-based motion estimation method was proposed in Fan, T., et al., D-DPCC: Deep Dynamic Point Cloud Compression via 3D Motion Prediction, IN PROCEEDINGS OF THE THIRTY-FIRST INTERNATIONAL JOINT CONF. ON ARTIFICIAL INTERLLIGENCE (2022) (“Fan”). This approach explicitly generates a motion bitstream with the definition of a motion estimation and motion compensation pair. This approach may be more efficient in learning or inferring more deformable motion because this approach explicitly sends motion information through a motion bitstream. However, this method only considers a single-level motion.

A patched dynamic point cloud compression (DPCC) was proposed in Pan, Z., et al., patchDPCC: A Patchwise Deep Compression Framework for Dynamic Point Clouds, IN PROCEEDINGS OF THE AAAI CONF. ON ARTIFICIAL INTELLIGENCE (2024) (“Pan”) to generate a fixed sized and temporally correlated patch group for each group of frames. This approach also proposes a point-based compression module that leverages inter-frame correlation and point-wise features to improve reconstruction quality. The method may be efficient for slow and less deformable motions but may not be ideal for fast and highly deformable motions, such as ball or cloth movements.

In this application, the above issues are addressed, and the previously mentioned challenges are overcome. This application introduces a motion coding architecture in a learning-based DPCC framework. This application seeks to provide a design of an efficient inter-coding branch that hierarchically encodes and decodes motion information of each octree level with the guidance of its pre-coded parent level motion. In other designs, the motion information of each octree level may be coded independently.

This application introduces a hierarchical motion coding architecture and techniques for use with learning-based dynamic point cloud compression (DPCC). For some of those previously-proposed motion coding techniques, the motion features may be coded at different levels of the octree hierarchy. However, in those past works, the motion features were coded independently per level, with at least two disadvantages as understood. First, the motion was not truly hierarchical, since the motion was coded separately for each child octree level (without considering motion features already coded in previous levels from zero to the parent level). Second, the coding of motion information at each octree level was inefficient, because the coding did not consider the context of the parent-level motion features.

Unlike some of these previously-proposed motion coding techniques, the motion feature from the parent octree level is applied to the current level to further enhance the predictor feature for inter-coding. The parent motion is first upsampled to match the resolution of the current level. This coarse motion feature is used to shift the given reference frame. This shifted feature in high dimensional space allows residual motion to be generated between the parent and current levels. This residual motion feature eventually helps improve the inter-coding efficiency through the improved motion. During the top-down coding process, the full motion feature is computed to support the next octree level motion coding.

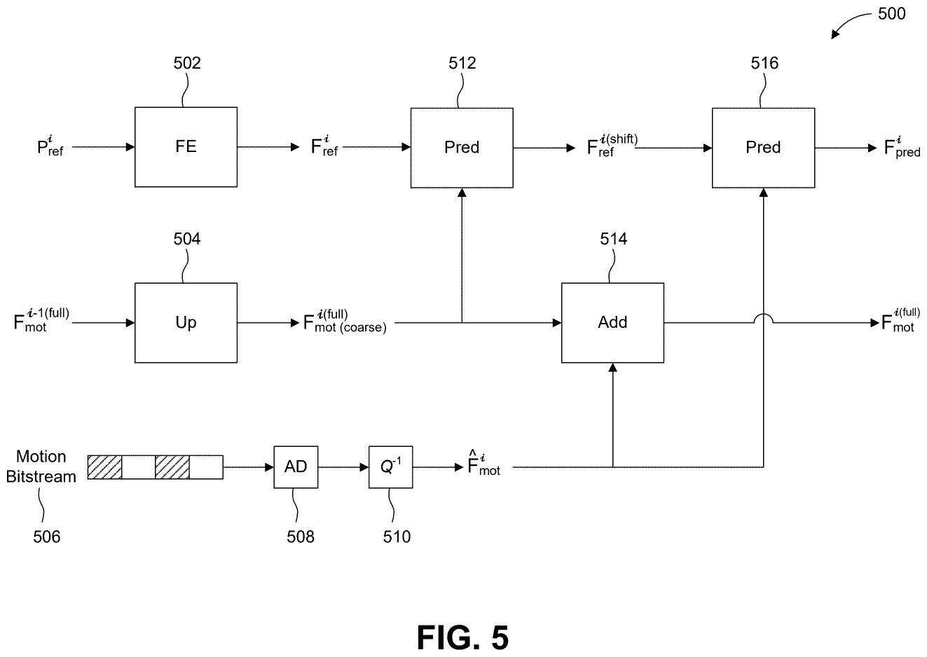

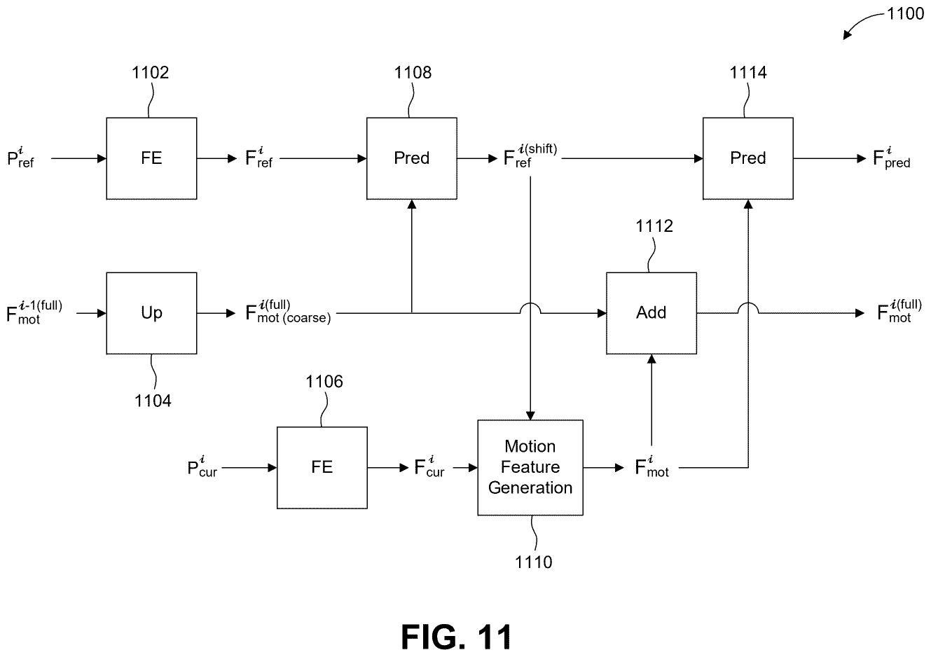

Stated differently, this application overcomes these stated issues by introducing a coding structure that considers the motion feature context from the parent octree level (i−1). This context includes all of the coarser level motion previously coded (that is, hierarchical motion features from levels 0 to (i−1). This coarse motion feature data is upsampled for compatibility with the current octree level (level i) and used in a first stage prediction block to effectively shift the reference point cloud features (e.g., features from a previous point cloud in the time sequence) for improving the motion searching and the prediction accuracy in the next stages. Since all coarse motion from the parent and other previous octree levels is accounted for, the application is able to generate a residual motion feature that captures only the finer level motion from the current octree level (level i). This residual motion feature is added to the upsampled coarse motion feature from the parent and previous levels and used (with the shifted reference point cloud features as input) to generate the predicted point cloud features. See FIG. 11 (encoder side) and FIG. 5 (decoder side) for a description of how this process may work for some embodiments.

### Hierarchical Motion

Given an octree level i, the motion information between the current and reference frames defined in its parent level i−1 contains larger and coarser motion from the point of view of level i. For estimating fine-grained motion at level i, an initial large step shifting based on its parent motion is beneficial for a later focus on fine motion estimation. This initial coarse search based on the reference frame moves the starting point to a refined location for the next phase of search. A later search step may focus on only fine motion within a smaller search range. In this application, a hierarchical motion coding framework may be used to emulate such a search methodology.

### Feature-Based Hierarchical Motion Coding

Two ways may be used to represent motion in a learning-based compression framework. A motion vector or a motion feature are mostly used to convey motion information between frames. A motion vector is usually defined in 3D space. A motion vector has finer controllability because each point may be moved to a specific position. This representation is often used in traditional video coding. On the other hand, a motion feature may be defined in a higher dimensional space and usually extracted from neural network layers such as CNN or MLP. The application discusses a method that applies this motion feature as a base motion representation. A motion feature generation process for some embodiments is described in the following sub-section.

### Motion Feature Generation

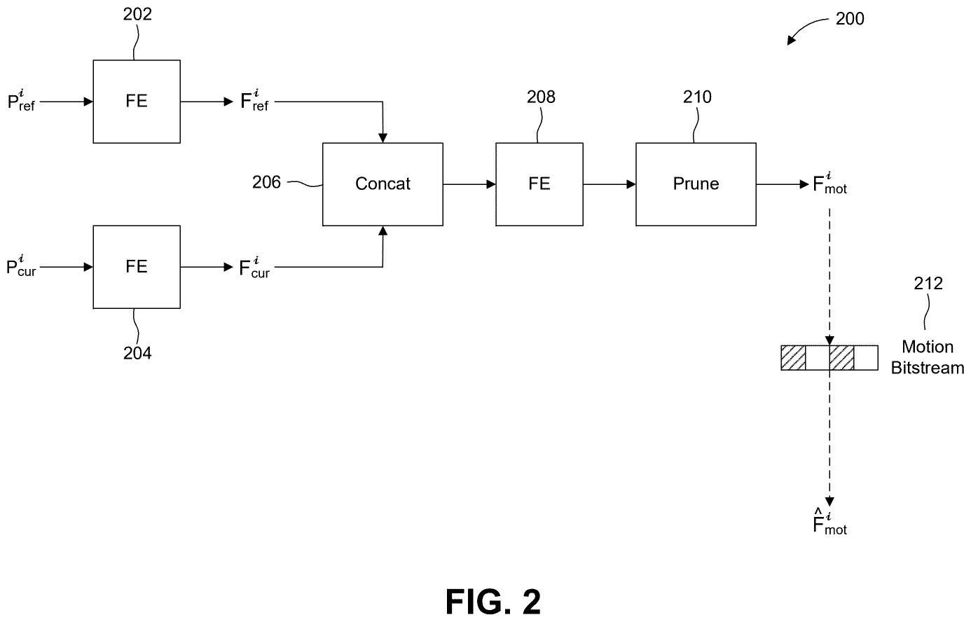

FIG. 2 is a schematic illustration showing an example motion feature generation process according to some embodiments. As illustrated in FIG. 2, a motion feature generation block 200 performs feature extractions (FE) 202, 204 of a reference feature

$${F}_{ref}^{i}$$

and a current feature

$${F}_{cur}^{i}$$

from two given point clouds

$${P}_{ref}^{i} and {P}_{cur}^{i}$$

defined at the i-th octree level. The

$${F}_{ref}^{i} and {F}_{cur}^{i}$$

features are concatenated 206 on the points where the features coexist in both frames. If defined in one frame, the feature is concatenated with a zero feature. The concatenated feature is processed through the feature extraction (FE) block 208, which represents one or a series of CNN or MLP layers. In some embodiments, additional feature enhancement layers, such as an Inception-ResNet (IRN) as discussed in Szegedy, C., et al., Inception-v4, Inception-ResNet and the Impact of Residual Connections on Learning, 31:1 IN PROCEEDINGS OF THE AAAI CONF. ON ARTIFICIAL INTELLIGENCE (2017) (“Szegedy”), a voxel transformer as discussed in Mao, J., et al., Voxel Transformer for 3D Object Detection, IN PROCEEDINGS OF THE IEEE/CVF INTERNATIONAL CONF. ON COMP. VISION (ICCV) (2021) (“Mao”), or a Deep Distribution-Aware Network (DDA-Net) as discussed in Ahn, J., et al., DDA-Net: Deep Distribution-Aware Network for Point Cloud Compression, IN 2023 IEEE INTERNATIONAL SYMPOSIUM ON CIRCUITS AND SYSTEMS (ISCAS) (2023) (“Ahn”), among others, are applied along with the CNN layers. At this point, the feature vectors are defined on the union of points where the

$${F}_{ref}^{i} and {F}_{cur}^{i}$$

are defined. To ease the merging process, for some embodiments, a pruning block 210 may prune out the feature vectors that are not defined on

$${F}_{ref}^{i}$$

and then output an i-th motion feature

$${F}_{mot}^{i} .$$

The

$${F}_{mot}^{i}$$

is a non-quantized motion feature. After the motion feature generation process, a motion bitstream 212 for the i-th level is quantized and encoded through a motion entropy encoder. In the decoder, the quantized motion feature

$${\hat{F}}_{mot}^{i}$$

is decoded through an entropy decoder. This design allows the quantized motion features to be identical between the encoder and decoder. The quantization and the entropy coder are shown as dashed arrows in FIG. 2.

### Motion Decoder

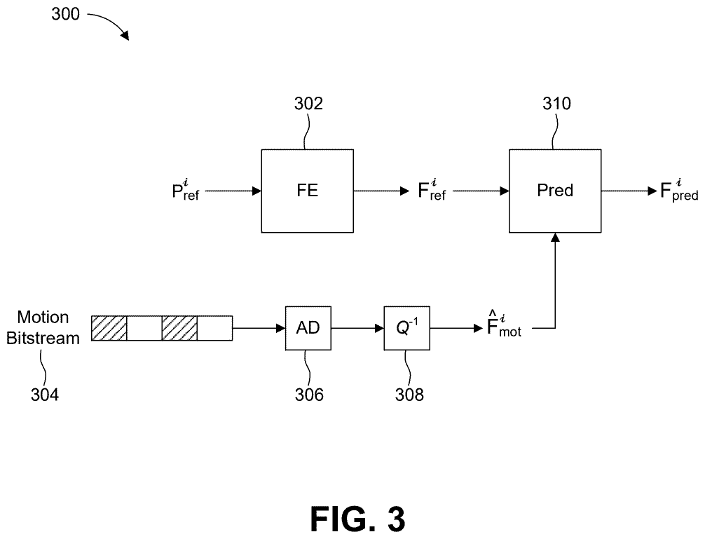

FIG. 3 is a schematic illustration showing an example motion decoder according to some embodiments. As illustrated in the example motion decoder 300 of FIG. 3, a motion feature

$${\hat{F}}_{mot}^{i}$$

is decoded from the given motion bitstream 304, through an arithmetic decoding (AD) block 306 and a dequantization (Q⁻¹) block 308. A feature extraction (FE) block 302 performs a feature extraction of a reference feature

$${F}_{ref}^{i}$$

from a point cloud

$${P}_{ref}^{i} .$$

The decoded motion feature

$${\hat{F}}_{mot}^{i}$$

at the i-th octree level and the extracted reference frame feature

$${F}_{ref}^{i}$$

are accessible from the decoder. In this previous motion decoder design, the

$${\hat{F}}_{mot}^{i} and {F}_{ref}^{i}$$

are inputted to the predictor generation (Pred) block 310, which estimates a predictor feature

$${F}_{pred}^{i} .$$

### The

$${F}_{pred}^{i}$$

may be used as a conditional feature in the main coding branch. More details on the “Pred” block 310 are described in the following sub-section.

In this design, the motion feature is processed independently for each level, making the DPCC framework difficult to correlate motion information between different octree levels. Also, using a reference feature directly extracted from the reference frame may limit the neural network capabilities to understand finer motions.

### Predictor Generation

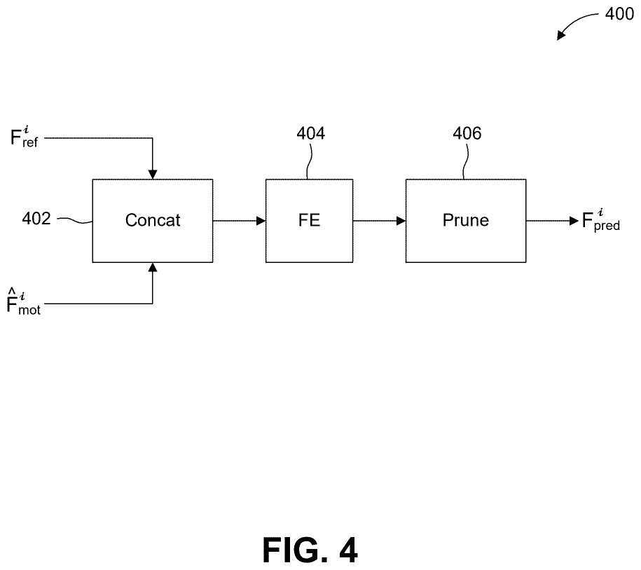

FIG. 4 is a schematic illustration showing an example predictor generation process according to some embodiments. As depicted in FIG. 4 (and FIG. 3), a decoded motion feature

$${\hat{F}}_{mot}^{i}$$

and the reference feature

$${F}_{ref}^{i}$$

of octree level i are the inputs to the predictor generation (Pred) block 400. The “Pred” block 400 applies the given motion information to the given reference frame and outputs a predicted feature

$${F}_{pred}^{i} ,$$

which predicts the i-th level of the current coding frame.

The input features

$${F}_{ref}^{i} and {\hat{F}}_{mot}^{i}$$

are concatenated 402 (which may be done in the same manner as the concatenation described in the motion feature generation process of FIG. 2). The feature extraction (FE) 404 with CNN layers, followed by a feature enhancement, such as one of the ones discussed in Szegedy, Mao, and/or Ahn may be implemented to improve the quality of predictor feature. Additional CNN layers are applied to embed enhanced features, which may be pruned 406 to define predicted features on the current points.

### Hierarchical Motion Decoder

The motion decoder design of FIG. 3 includes two parallel processes: (1) feature extraction (FE) of the previously decoded reference frame; and (2) motion feature decoding from a motion bitstream. The “Pred” block takes the outputs of both parallel processes to generate a predicted feature.

FIG. 5 is a schematic illustration showing an example hierarchical motion decoder according to some embodiments. In the hierarchical motion decoder 500 of FIG. 5, three parallel processes are used.

As illustrated in the middle row of FIG. 5, a parent level motion process is understood to be one of the novel designs for a decoder. The

$${F}_{mot}^{i - 1 ( full )}$$

is a full motion feature defined in the parent level of current octree level i. The term “full” means that the motion information is accumulated from the root to the i−1 octree level. To match this i−1 level full motion feature to the i-th level resolution, an up-sampling (Up) block 504 is applied to generate a coarser motion in higher granularity

$${F}_{mot ( coarse )}^{i ( full )} .$$

More detail on the “Up” block 504 is provided later.

Another parallel process in the bottom row of FIG. 5 decodes a motion feature

$${\hat{F}}_{mot}^{i}$$

from a motion bitstream 506 through arithmetic decoding (AD) 508 and dequantization (Q⁻¹) 510. This process may be identical to the previous motion decoder for some embodiments. However, note that the motion feature

$${\hat{F}}_{mot}^{i}$$

of this hierarchical motion coding is a residual motion between level i−1 and i. In the previous motion coding, the motion feature

$${\hat{F}}_{mot}^{i}$$

is a full feature representing motion in i-th level only. The residual motion

$${\hat{F}}_{mot}^{i}$$

and the up-sampled motion

$${F}_{mot ( coarse )}^{i ( full )}$$

are combined through and adding (Add)block 514 to generate full motion of the current i-th octree level. This full motion feature

$${F}_{mot}^{i ( full )}$$

is used for the I+1 level motion coding. More detail on the “Add” block 514 is given later. For some embodiments, the decoded motion feature

$${\hat{F}}_{mot}^{i}$$

is only the residual motion (which is the finer motion for the current octree level i—the motion that was not hierarchically coded already for octree levels 0to the parent level (i−1)). To generate the full motion for the current i-th level, this residual motion is added to the upsampled coarse/full motion inherited from the previously coded layers.

The last parallel decoding process is in the top row of FIG. 5. A feature extraction (FE) block 502 performs a feature extraction of a reference feature

$${F}_{ref}^{i}$$

from a point cloud

$${P}_{ref}^{i} .$$

The extracted reference feature

$${F}_{ref}^{i}$$

goes through a two-step prediction for improving accuracy of th outputting predictor feature

$${F}_{pred}^{i} .$$

In the first prediction step, the

$${F}_{ref}^{i} and {F}_{mot ( coarse )}^{i ( full )}$$

are inputted to the “Pred” block 512 to generate an initial (rough) shifted reference feature

$${F}_{ref}^{i ( shift )} .$$

This initial shift supports the searching of the second prediction step, in which the decoded residual motion feature

$${\hat{F}}_{mot}^{i}$$

is inputted along with the

$${F}_{ref}^{i ( shift )}$$

the “Pred” block 516 to output the final predicted feature

$${F}_{pred}^{i} .$$

For some embodiments, the first prediction block 512 uses the “coarse” motion from the parent level to shift the reference point cloud.

In a hierarchical motion coding architecture, the previous level motion feature assists generating the current level motion feature. In some embodiments, a two-step prediction is extended to an n-step (n>2) prediction design. The residual motion feature

$${\hat{F}}_{mot}^{i}$$

contains a finer motion for the i-th level.

### Motion Feature Up-Sampling

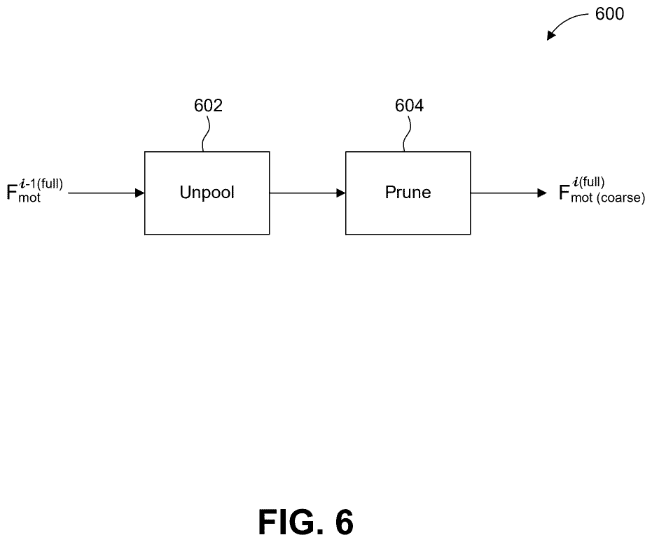

FIG. 6 is a schematic illustration showing an example motion feature upsampling process according to some embodiments. As depicted in FIG. 6, the full motion feature of the parent level of the current octree level i,

$${F}_{mot}^{i - 1 ( full )} ,$$

is an input to the motion feature up-sampling (Up) block 600. Inside the up-sampling (Up) block 600, an un-pooling (Unpool) block 602 divides each occupied voxel into 8 voxels. Since the point cloud is presented in the format of octree, a pruning (Prune) block 604 removes the un-pooled voxels, which are deemed empty. In some embodiments, the empty voxels of

$${F}_{mot}^{i ( full )}$$

are pruned. In some embodiments, the empty voxels of

$${P}_{ref}^{i}$$

are pruned. The “Up” block 600 outputs an up-sampled coarse motion feature

$${F}_{mot ( coarse )}^{i ( full )} .$$

In some embodiments, a series of neural network layers may precede the “Prune” block 604 to enhance the motion feature.

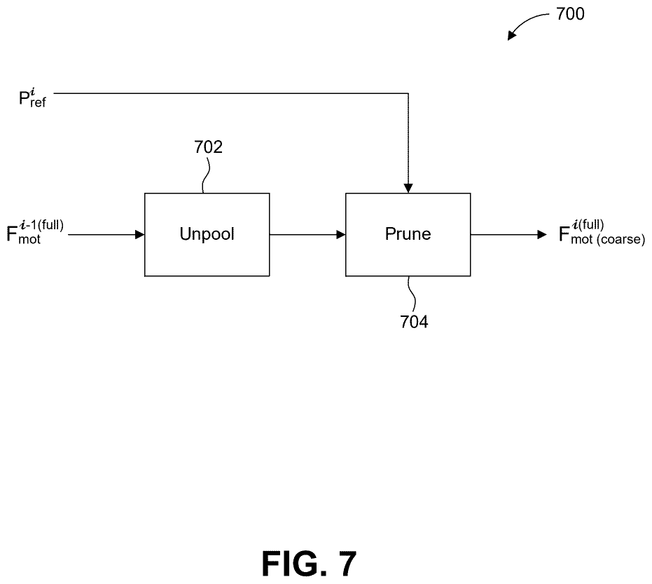

FIG. 7 is a schematic illustration showing an example motion feature upsampling process with a reference according to some embodiments. The example motion feature upsampling process 700 of FIG. 7 uses a reference. Inside the up-sampling (Up) block 700, an un-pooling (Unpool) block 702 divides each occupied voxel into 8 voxels. Since the point cloud is presented in the format of octree, a pruning (Prune) block 704 removes the un-pooled voxels, which are deemed empty. In some embodiments, the empty voxels of

$${P}_{ref}^{i}$$

are pruned. The “Up” block 700 outputs an up-sampled coarse motion feature

$${F}_{mot ( coarse )}^{i ( full )} .$$

### Motion Feature Addition

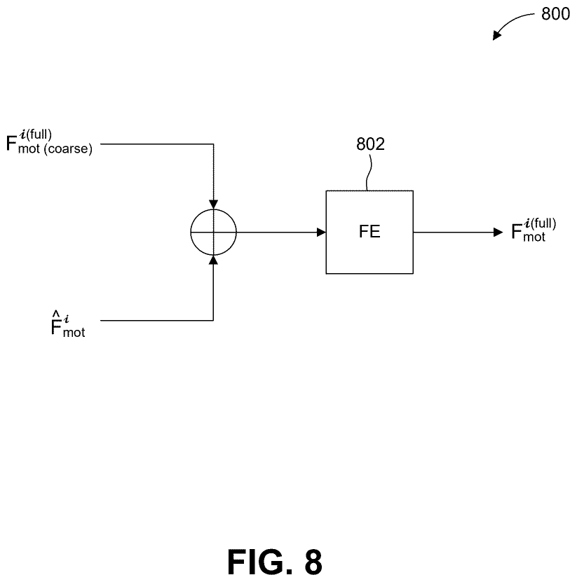

FIG. 8 is a schematic illustration showing an example motion feature addition process according to some embodiments. As depicted in the example motion feature addition process 800 of FIG. 8, the up-sampled coarse motion feature

$${F}_{mot ( coarse )}^{i ( full )}$$

and the decoded residual motion feature

$${\hat{F}}_{mot}^{i}$$

are the inputs to the motion feature addition (Add) block. The ⊕ operator, adds the

$${\hat{F}}_{mot}^{i}$$

to

$${F}_{mot ( coarse )}^{i ( full )} .$$

The sum of these motion features is enhanced through the feature extraction (FE) block 802 to output the full motion feature

$${F}_{mot}^{i ( full )}$$

of the current octree level i, through the feature extraction (FE) layers. In some embodiments, the ⊕ operator is replaced by a concatenation block.

### Motion Encoder

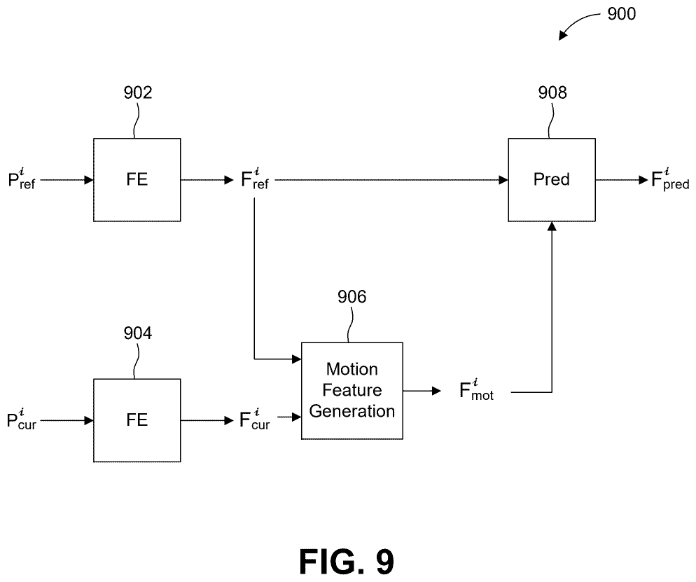

FIG. 9 is a schematic illustration showing an example motion encoder according to some embodiments. As illustrated in FIG. 9, the previous motion encoder design is similar to the previous motion decoder (see FIG. 3). The motion encoder 900 additionally has a motion feature generation block 906, when compared to the decoder architecture. The motion feature generation block 906 takes as inputs the

$${F}_{cur}^{i}$$

and

$${F}_{ref}^{i} ,$$

which are the results of the feature extraction (FE) blocks 902, 904 for the current and reference frames, respectively. The motion feature generation block 906 outputs the motion feature

$${F}_{mot}^{i} .$$

The motion feature

$${F}_{mot}^{i}$$

and the reference feature

$${F}_{ref}^{i}$$

are inputted to the predictor generation (Pred) block 908, which estimates a predictor feature

$${F}_{pred}^{i} .$$

The “FE” blocks 902, 904 for the reference frame

$${F}_{ref}^{i}$$

and the current frame

$${F}_{c u r}^{i}$$

as well as generation of the predicted feature

$${F}_{p red}^{i} ,$$

remain the same as the decoder architecture for some embodiments.

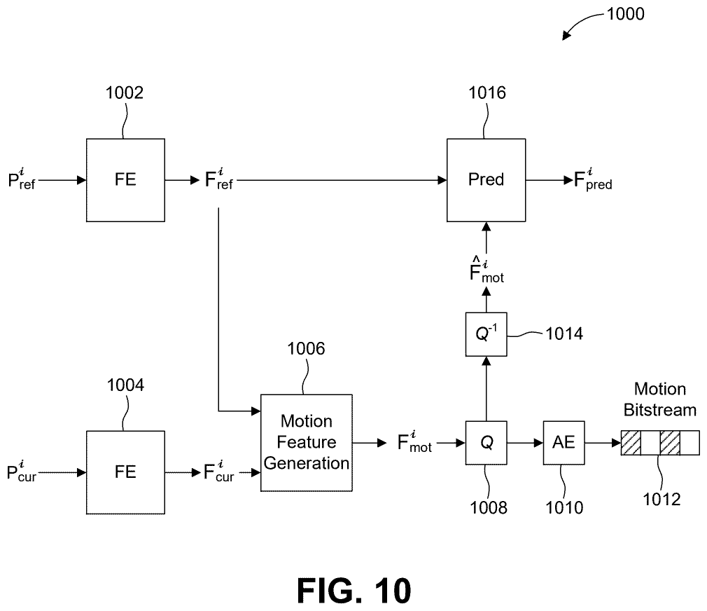

FIG. 10 is a schematic illustration showing an example explicit motion feature encoder according to some embodiments. For an explicit motion encoder 1000, a motion bitstream 1012 is generated on the motion coding branch. This concept is applied by quantizing (Q) 1008 then arithmetic encoding (AE) 1010 the motion feature

$${F}_{m o t}^{i}$$

into a motion bitstream 1012 as shown in FIG. 10. This explicit motion encoder 1000 also emulates the decoding of a motion bitstream to output a quantized motion feature

$${\hat{F}}_{mot}^{i} .$$

In the diagram of FIG. 10, this process is shown as a quantize (Q) block 1008 and a dequantize (Q⁻¹) block 1014 in-between the motion feature

$${F}_{mot}^{i}$$

and the quantized motion feature

$${\hat{F}}_{mot}^{i} .$$

Additionally, the explicit motion encoder 1000 has a motion feature generation block 1006. The motion feature generation block 1006 takes as inputs the

$${F}_{cur}^{i} and {F}_{ref}^{i} ,$$

which are the results of the feature extraction (FE) blocks 1002, 1004 for the current and reference frames, respectively. The motion feature generation block 1006 outputs the motion feature

$${F}_{mot}^{i} .$$

The motion feature

$${F}_{mot}^{i}$$

and the reference feature

$${F}_{ref}^{i}$$

are inputted to the predictor generation (Pred) block 1016, which estimates a predictor feature

$${F}_{p r e d}^{i} .$$

The same description given with respect to the motion decoder also applies to the motion encoder for some embodiments.

### Hierarchical Motion Encoder

The motion encoder design of FIGS. 9 and 10 includes of three parts: (1) feature extractions (FE) of the current and reference frames; (2) motion feature generation; and (3) predictor generation (Pred) blocks.

FIG. 11 is a schematic illustration showing an example hierarchical motion encoder according to some embodiments. In the hierarchical motion encoder 1100 of FIG. 11, the previous three parts are further extended to include two more parts: (4) a parent level motion process; and (5) a two-step prediction process. As was described regarding the hierarchical motion decoding, the parent motion feature

$${F}_{mot}^{i - 1 ( f𝔲ll )}$$

is up-sampled (Up) 1104, then updated (Add) 1112 to output the current i-th octree level full motion feature

$${F}_{mot}^{i ( f𝔲ll )} .$$

In parallel with this motion feature update, in the first prediction block 1108, the reference feature

$${F}_{ref}^{i}$$

undergoes an initial (rough) shift to generate

$${F}_{r e f}^{i ( shift )}$$

by applying the up-sampled parent level motion feature

$${F}_{mot ( coarse )}^{i ( full )} .$$

For some embodiments, the first prediction block 1108 uses the “coarse” motion from the parent level to shift the reference point cloud. The reference feature

$${F}_{ref}^{i}$$

and the current feature

$${F}_{cur}^{i}$$

are feature extracted (FE) 1102, 1106 from i-th level of the current point cloud frame

$${P}_{cur}^{i}$$

and input to the motion feature generation block 1110 to output the residual motion feature

$${F}_{mot}^{i} .$$

in the second prediction block 1114, the initial (rough) shifted feature

$${F}_{ref}^{i ( shift )}$$

and the residual motion feature

$${F}_{mot}^{i}$$

are used as inputs to predict the final predicted feature

$${F}_{pred}^{i} .$$

For some embodiments, the motion feature generation block 1110 uses the already-shifted reference point cloud features. Thus, the motion from octree levels 0 to the parent level (i−1) are already accounted for. The outputted motion feature is residual motion (which is only the finer motion associated with the current octree level (i)).

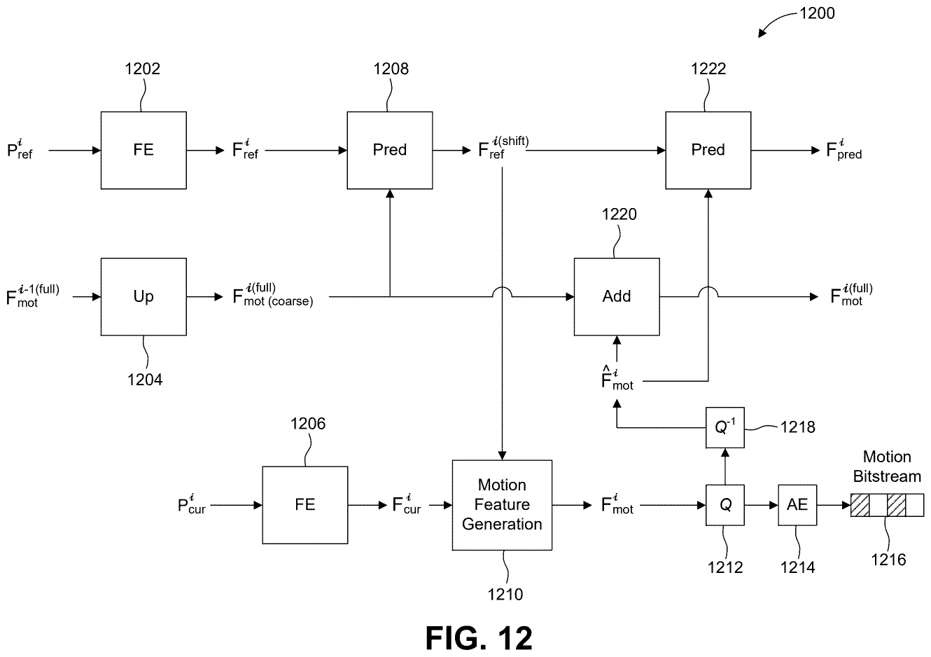

FIG. 12 is a schematic illustration showing an example explicit hierarchical motion encoder according to some embodiments. Similar to FIG. 10, for the hierarchical motion encoder, a motion bitstream 1216 is generated for the explicit motion coding. FIG. 12 illustrates this architecture 1200 with an additional motion bitstream 1216, which is quantized (Q) 1212 then arithmetic encoded (AE) 1214 from the motion feature

$${F}_{mot}^{i} .$$

The decoded motion feature

$${\hat{F}}_{mot}^{i}$$

is emulated through a quantize (Q) block 1212 and a dequantize (Q⁻¹) block 1218 in-between the motion feature

$${F}_{mot}^{i}$$

and the decoded motion feature

$${\hat{F}}_{mot}^{i} .$$

Additionally, the hierarchical motion encoder 1200 has the parent motion feature

$${F}_{mot}^{i - 1 ( full )}$$

up-sampled (Up) 1204, then updated (Add) 1220 to output the current i-th octree level full motion feature

$${F}_{mot}^{i ( full )} .$$

In parallel with this motion feature update, in the first prediction block 1208, the reference feature

$${F}_{ref}^{i}$$

undergoes an initial (rough) shift to generate

$${F}_{r e f}^{i ( shift )}$$

by applying the up-sampled parent level motion feature

$${F}_{mot ( coarse )}^{i ( full )} .$$

The reference feature

$${F}_{ref}^{i}$$

and the current feature

$${F}_{cur}^{i}$$

are feature extracted (FE) 1202, 1206 from the i-th level of the reference point cloud

$${P}_{ref}^{i}$$

and the i-th level of the current point cloud frame

$${P}_{c u r}^{i} ,$$

respectively. Then the reference feature

$${F}_{c u r}^{i}$$

and the current feature

$${F}_{r e f}^{i ( shift )}$$

are inputted to the motion feature generation block 1210 to output the residual motion feature

$${F}_{mot}^{i} .$$

In the second prediction block 1222, the initial (rough) shifted feature

$${F}_{r e f}^{i ( shift )}$$

and the residual motion feature

$${F}_{mot}^{i} or {\hat{F}}_{mot}^{i}$$

are used as inputs to predict the final predicted feature

$${F}_{pred}^{i} .$$

The same description given with respect to the hierarchical motion decoder also applies to the hierarchical motion encoder for some embodiments.

### Hierarchical Motion in Unified DPCC

The hierarchical motion encoder and decoder described herein are compatible with the unified DPCC architecture with hierarchical feature coding. The motion coder replaces the motion branch for improved inter coding. The encoder and decoder are described in the following sub-sections.

### Hierarchical Motion Encoder in Unified DPCC

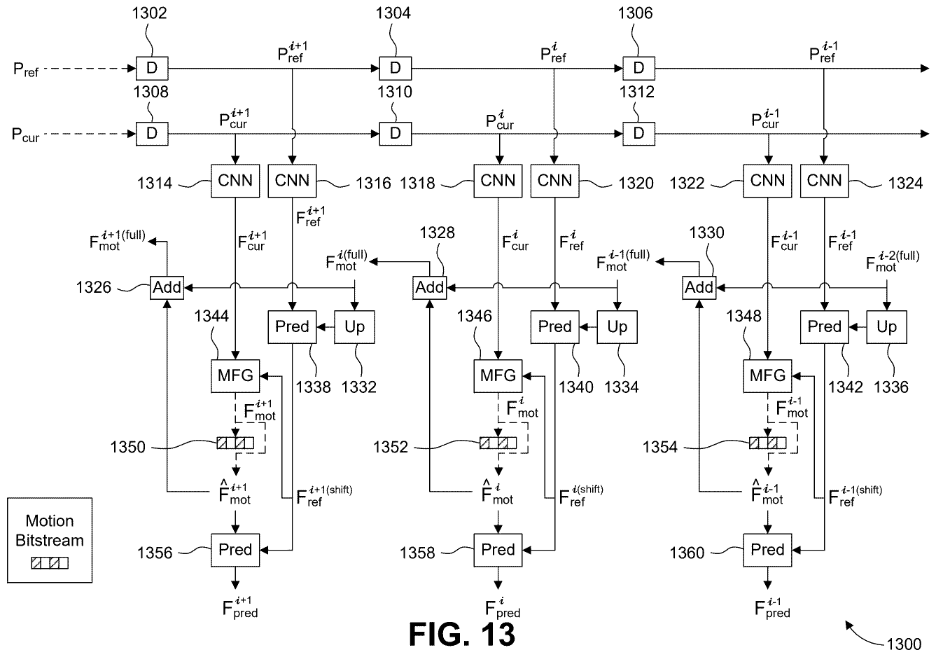

FIG. 13 is a schematic illustration showing an example unified DPCC hierarchical motion encoder according to some embodiments. In FIG. 13, a hierarchical motion encoding process 1300 is illustrated as right to left columns for octree levels i−1, i, and i+1.

For the (i−1)-th level encoding, input point cloud frames P cur and Pref are down-sampled (D) 1302, 1304, 1306, 1308, 1310, 1312 to the (i−1)-th octree level. The down-sampled point clouds

$${P}_{cur}^{i - 1} and {P}_{ref}^{i - 1}$$

go through “CNN” layers 1322, 1324 to extract features

$${F}_{c u r}^{i - 1} and {F}_{ref}^{i - 1} .$$

An initial shifting of the reference frame is predicted 1342 by up-sampling (Up) 1336 the parent motion feature

$${F}_{mot}^{i - 2 ( full )}$$

and then applying the reference feature

$${F}_{ref}^{i - 1}$$

to the “Pred” block 1342. The shifted feature

$${F}_{ref}^{i - 1 ( shift )}$$

is inputted to the motion feature generation (MFG) block 1348, along with the current frame feature

$${F}_{cur}^{i - 1} ,$$

to generate the motion feature

$${F}_{mot}^{i - 1} .$$

This estimated motion feature represents residual motion between the i−2-th and i−1-th levels motions. This motion feature is packed (quantization and entropy encoding are shown as a dashed arrow) into a motion bitstream 1354 for the decoder. In parallel, a quantized motion feature

$${\hat{F}}_{mot}^{i - 1}$$

is generated through the dashed line between

$${F}_{mot}^{i - 1} and {\hat{F}}_{mot}^{i - 1} .$$

This quantized motion feature

$${\hat{F}}_{mot}^{i - 1}$$

is added (Add) 1330 to the full motion feature

$${F}_{mot}^{i - 2 ( full )}$$

in the parent level to output the i−1-th level full motion feature

$${F}_{mot}^{i - 1 ( full )} ,$$

which is used for the for the i-th octree level motion encoding. The residual motion feature

$${\hat{F}}_{mot}^{i - 1}$$

is also applied with the shifted reference frame feature

$${F}_{ref}^{i - 1}$$

as inputs to the “Pred” block 1360 to generate the level i−1predictor feature

$${F}_{pred}^{i - 1} .$$

The predictor feature

$${F}_{pred}^{i - 1}$$

may be inputted to the main coding branch.

For the i-th level encoding, input point cloud frames P_{cur} and P_{ref} are down-sampled (D) 1302, 1304, 1308, 1310 to the i-th octree level. The down-sampled point clouds

$${P}_{cur}^{i} and {P}_{ref}^{i}$$

go through “CNN” layers 1318, 1320 to extract features

$${F}_{cur}^{i} and {F}_{ref}^{i} .$$

An initial shifting of the reference frame is predicted 1340 by up-sampling (Up) 1334 the parent motion feature

$${F}_{mot}^{i - 1 ( full )}$$

and then applying the reference feature

$${F}_{ref}^{i}$$

to the “Pred” block 1340. The shifted feature

$${F}_{ref}^{i ( shift )}$$

is inputted to the motion feature generation (MFG) block 1346, along with the current frame feature

$${F}_{cur}^{i} ,$$

to generate the motion feature

$${F}_{mot}^{i} .$$

This motion feature represents residual motion between the i−1-th and i-th levels motions. This motion feature is packed (quantization and entropy encoding are shown as a dashed arrow) into a motion bitstream 1352 for the decoder. In parallel, a quantized motion feature

$${\hat{F}}_{mot}^{i}$$

is generated through the dashed line between

$${F}_{mot}^{i} and {\hat{F}}_{mot}^{i} .$$

This quantized motion feature

$${\hat{F}}_{mot}^{i}$$

is added (Add) 1328 to the full motion feature

$${F}_{mot}^{i - 1 ( full )}$$

in the parent level to output the i-th level full motion feature

$${F}_{mot}^{i ( full )} ,$$

which is used for the i-th octree level motion encoding. The residual motion feature

$${\hat{F}}_{mot}^{i}$$

is also applied with the shifted reference frame feature

$${F}_{ref}^{i ( shift )}$$

as inputs to the “Pred” block 1358 to generate the level i predictor feature

$${F}_{pred}^{i} .$$

The predictor feature

$${F}_{pred}^{i}$$

may be inputted to the main coding branch.

For the (i+1)-th level encoding, input point cloud frames P_{cur} and P_{ref} are down-sampled (D) 302, 1308 to the (i+1)-th octree level. The down-sampled point clouds

$${P}_{cur}^{i + 1} and {P}_{ref}^{i + 1}$$

go through “CNN” layers 1314, 1316 to extract features

$${F}_{cur}^{i + 1} and {F}_{ref}^{i + 1} .$$

An initial shifting of the reference frame is predicted 1338 by up-sampling (Up) 1332 the parent motion feature

$${F}_{mot}^{i ( full )}$$

and then applying the reference feature

$${F}_{ref}^{i + 1}$$

to the “Pred” block 1338. The shifted feature

$${F}_{ref}^{i + 1 ( shift )}$$

is inputted to the motion feature generation (MFG) block 1344, along with the current frame feature

$${F}_{cur}^{i + 1} .$$

to generate the motion feature

$${F}_{mot}^{i + 1} .$$

This estimated motion feature represents residual motion between the i-th and i+1-th levels motions. This motion feature is packed (quantization and entropy encoding are shown as a dashed arrow) into a motion bitstream 1350 for the decoder. In parallel, a quantized motion feature

$${\hat{F}}_{mot}^{i + 1}$$

is generated through the dashed line between

$${F}_{mot}^{i + 1} and {\hat{F}}_{mot}^{i + 1} .$$

This quantized motion feature

$${\hat{F}}_{mot}^{i + 1}$$

is added (Add) 1326 to the full motion feature

$${F}_{mot}^{i ( full )}$$

in the parent level to output the i+1-th level full motion feature

$${F}_{mot}^{i + 1 ( full )} ,$$

which is used for the i+2-th octree level motion encoding. The residual motion feature

$${\hat{F}}_{mot}^{i + 1}$$

is also applied with the shifted frame feature

$${F}_{ref}^{i + 1 ( shift )}$$

as inputs to the “Pred” block 1356 to generate the level i+1 predictor feature

$${F}_{pred}^{i + 1} .$$

The predictor feature

$${F}_{pred}^{i + 1}$$

may be inputted to the main coding branch.

In some embodiments, a “conditional encoder” takes the Fⁱ_{pred} as input for applying the inter coded feature into the main feature coding branch of the unified DPCC framework.

### Hierarchical Motion Decoder in Unified DPCC

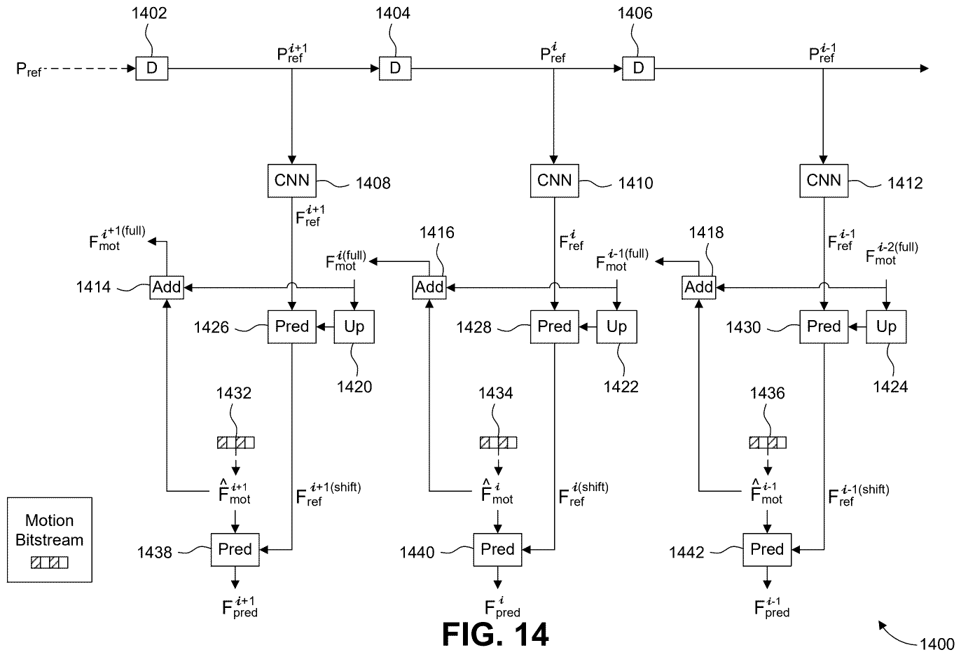

FIG. 14 is a schematic illustration showing an example unified DPCC hierarchical motion decoder according to some embodiments. As illustrated in FIG. 14, the hierarchical motion decoding in the unified DPCC is a subset of the hierarchical motion encoding process that is depicted in FIG. 13. Only the reference point cloud frame is down-sampled (D). All the input and output of the motion feature generation (MFG) including the block are not part of the decoder. Finally, the residual motion feature \hat{F}ⁱₘₒₜ is directly processed from the given motion bitstream through an entropy decoder. This process is simplified to a dashed arrow in FIG. 14. The predicted feature

$${F}_{pred}^{i}$$

of each level may be inputted to the main coding branch. In some embodiments, a “conditional decoder” takes the

$${F}_{pred}^{i}$$

as input for applying the inter coded feature into the main feature coding branch of the unified DPCC framework.

In FIG. 14, a hierarchical motion decoding process 1400 is illustrated as right to left columns for octree levels i−1, i, and i+1.

For the i−1-th level decoding, input point cloud frame Pref is down-sampled (D) 1402, 1404, 1406 to the i−1-th octree level. The down-sampled point cloud

$${P}_{ref}^{i - 1}$$

goes through “CNN” layers 1412 to extract feature

$${F}_{ref}^{i - 1} .$$

An initial shifting of the reference frame is predicted 1430 by up-sampling (Up) 1424 the parent motion feature

$${F}_{mot}^{i ( full )}$$

and then applying the reference feature

$${F}_{ref}^{i - 1}$$

to the “Pred” block 1430. A quantized motion feature

$${\hat{F}}_{mot}^{i - 1}$$

is generated through the dashed line between the motion bitstream 1436 and

$${\hat{F}}_{mot}^{i - 1} .$$

This quantized motion feature

$${\hat{F}}_{mot}^{i - 1}$$

is added (Add) 1418 to the full motion feature

$${F}_{mot}^{i - 2 ( full )}$$

in the parent level to output the current level full motion feature

$${F}_{mot}^{i - 1 ( full )} ,$$

which is used for the i-th octree level motion encoding. The residual motion feature

$${\hat{F}}_{mot}^{i - 1}$$

and the shifted reference frame feature

$${F}_{ref}^{i - 1 ( shift )}$$

are applied as inputs to the “Pred” block 1442 to generate the level i−1 predictor feature

$${F}_{pred}^{i - 1} .$$

The predictor feature

$${F}_{pred}^{i - 1}$$

may be inputted to the main coding branch.

For the i-th level decoding, input point cloud frame P_{ref} is down-sampled (D) 1402, 1404 to the i-th octree level. The down-sampled point cloud

$${P}_{ref}^{i}$$

goes through “CNN” layers 1410 to extract feature

$${F}_{ref}^{i} .$$

An initial shifting of the reference frame is predicted 1428 by up-sampling (Up) 1422 the parent motion feature

$${F}_{mot}^{i - 1 ( full )}$$

and then applying the reference feature

$${F}_{ref}^{i}$$

to the “Pred” block 1428. A quantized motion feature

$${\hat{F}}_{mot}^{i}$$

is generated through the dashed line between the motion bitstream 1434 and

$${\hat{F}}_{mot}^{i} .$$

This quantized motion feature

$${\hat{F}}_{mot}^{i}$$

is added (Add) 1416 to the full motion feature

$${F}_{mot}^{i - 1 ( full )}$$

in the parent level to output the current level full motion feature

$${F}_{mot}^{i ( full )} ,$$

which is used for the i+1-th octree level motion encoding. The residual motion feature

$${\hat{F}}_{mot}^{i}$$

and the shifted reference frame feature

$${F}_{ref}^{i ( shift )}$$

are applied as inputs to the “Pred” block 1440 to generate the level i predictor feature

$${F}_{pred}^{i} .$$

### The

$${F}_{pred}^{i}$$

may be inputted to the amin coding branch.

For the i+1-th level decoding, input point cloud frame P_{ref} is down-sampled (D) 1402 to the i+1-th octree level. The down-sampled point cloud

$${P}_{ref}^{i + 1}$$

goes through “CNN” layers 1408 to extract feature

$${F}_{ref}^{i + 1} .$$

An initial shifting of the reference frame is predicted 1426 by up-sampling (Up) 1420 the parent motion feature

$${F}_{mot}^{i ( full )}$$

and then applying the reference feature

$${F}_{ref}^{i + 1}$$

to the “Pred” block 1426. A quantized motion feature

$${\hat{F}}_{mot}^{i + 1}$$

is generated through the dashed line between the motion bitstream 1432 and

$${\hat{F}}_{mot}^{i + 1} .$$

This quantized motion feature

$${\hat{F}}_{mot}^{i + 1}$$

is added (Add) 1414 to the full motion feature

$${F}_{mot}^{i ( full )}$$

in the parent level to output the current level full motion feature

$${F}_{mot}^{i + 1 ( full )} ,$$

which is used for the i+2-th octree level motion encoding. The residual motion feature

$${\hat{F}}_{mot}^{i + 1}$$

and the shifted reference frame feature

$${F}_{ref}^{i + 1 ( shift )}$$

are applied as inputs to the “Pred” block 1438 to generate the level i+1 predictor feature

$${F}_{pred}^{i + 1} .$$

The predictor feature

$${F}_{pred}^{i + 1}$$

may be inputted to the main coding branch.

### Training Strategies

The training of the proposed DPCC codec is briefly described below. It follows a stochastic strategy, where a particular octree level is selected for each training iteration. The purpose of this strategy is to reduce the complexity, e.g., the memory usage. Training the whole octree structure at once is a heavy process requiring a significant amount of GPU memory.

### Two-Stage Training

To educate a complex system, a two-stage or even a multiple-stage training strategy may be helpful to optimize the codec training. In one embodiment, the motion branch may be separately trained at the first stage focusing only on generating better motion information, then on the second stage, the motion branch may be combined into the main branch to process the training on the full unified DPCC framework.

In another embodiment, the octree levels may be separated. For example, during the first stage, only the first i octree levels from the root may be considered for the stochastic training. Then in the second stage, an octree level may be selected from the full octree levels for more complex training. This type of training is known as a curriculum training.

### Predicted Feature Supervision

To make predicted feature easier to reconstruct point cloud, a supervision technique may be applied to the training stage. A predicted feature

$${F}_{pred}^{i}$$

may be inputted into a series of up-sampling CNN layers to predict the reconstructing point cloud of i-th level as

$${P}_{pred}^{i} .$$

During the training, this predicted point cloud may be supervised by minimizing the difference between

$${P}_{pred}^{i}$$

and the original point cloud

$${P}_{cur}^{i} .$$

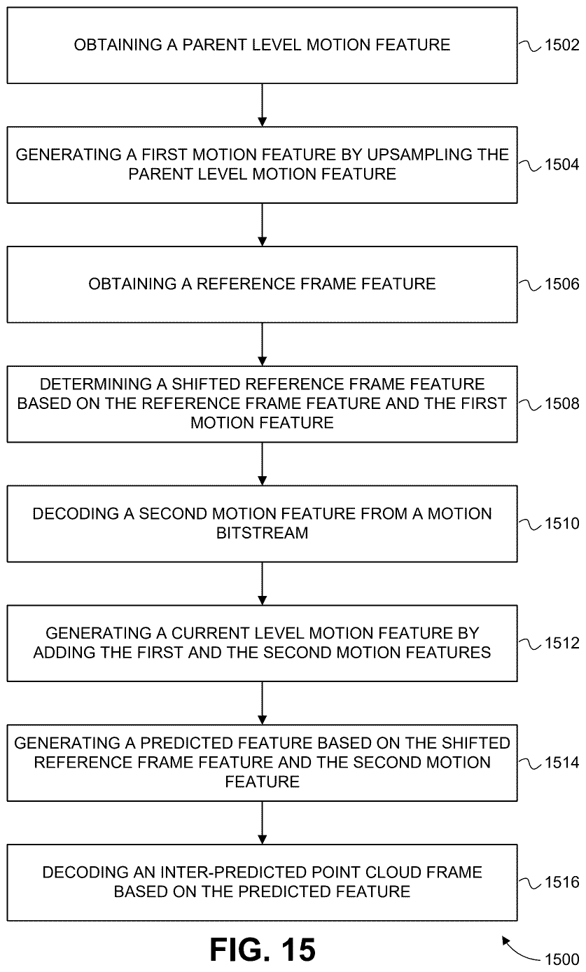

FIG. 15 is a flowchart illustrating an example learning-based predictive point cloud decoding process according to some embodiments. For some embodiments, an example process 1500 may include obtaining 1502 a parent level motion feature. For some embodiments, the example process 1500 may further include generating 1504 a first motion feature by upsampling the parent level motion feature. For some embodiments, the example process 1500 may further include obtaining 1506 a reference frame feature. For some embodiments, the example process 1500 may further include determining 1508 a shifted reference frame feature based on the reference frame feature and the first motion feature. For some embodiments, the example process 1500 may further include decoding 1510 a second motion feature from a motion bitstream. For some embodiments, the example process 1500 may further include generating 1512 a current level motion feature by adding the first and the second motion features. For some embodiments, the example process 1500 may further include generating 1514 a predicted feature based on the shifted reference frame feature and the second motion feature. For some embodiments, the example process 1500 may further include decoding 1516 an inter-predicted point cloud frame based on the predicted feature.

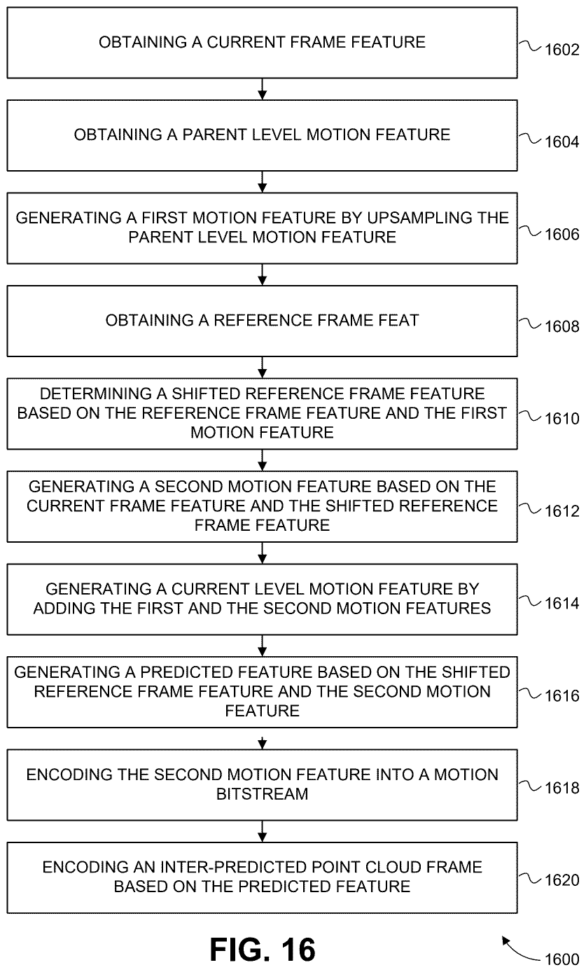

FIG. 16 is a flowchart illustrating an example learning-based predictive point cloud encoding process according to some embodiments. For some embodiments, an example process 1600 may include obtaining 1602 a current frame feature. For some embodiments, the example process 1600 may further include obtaining 1604 a parent level motion feature. For some embodiments, the example process 1600 may further include generating 1606 a first motion feature by upsampling the parent level motion feature. For some embodiments, the example process 1600 may further include obtaining 1608 a reference frame feature. For some embodiments, the example process 1600 may further include determining 1610 a shifted reference frame feature based on the reference frame feature and the first motion feature. For some embodiments, the example process 1600 may further include generating 1612 a second motion feature based on the current frame feature and the shifted reference frame feature. For some embodiments, the example process 1600 may further include generating 1614 a current level motion feature by adding the first and the second motion features. For some embodiments, the example process 1600 may further include generating 1616 a predicted feature based on the shifted reference frame feature and the second motion feature. For some embodiments, the example process 1600 may further include encoding 1618 the second motion feature into a motion bitstream. For some embodiments, the example process 1600 may further include encoding 1620 an inter-predicted point cloud frame based on the predicted feature.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: obtaining a parent level motion feature; generating a first motion feature by upsampling the parent level motion feature; obtaining a reference frame feature; determining a shifted reference frame feature based on the reference frame feature and the first motion feature; decoding a second motion feature from a motion bitstream; generating a current level motion feature by adding the first and the second motion features; generating a predicted feature based on the shifted reference frame feature and the second motion feature; and decoding an inter-predicted point cloud frame based on the predicted feature.

For some embodiments of the first example method, decoding the second motion feature includes: obtaining the motion bitstream; arithmetically decoding the motion bitstream; and dequantizing the arithmetically decoded motion bitstream to generate the second motion feature.

For some embodiments of the first example method, obtaining the reference frame includes: obtaining a reference point cloud; and performing a feature extraction of the reference point cloud to generate the reference frame.

For some embodiments of the first example method, upsampling the parent level motion feature includes: unpooling the parent level motion feature; and pruning the unpooled parent level motion feature to generate the first motion feature.

For some embodiments of the first example method, pruning the unpooled parent level motion feature is based on a reference point cloud.

For some embodiments of the first example method, generating the current level motion feature includes: adding the first and the second motion features; and performing a feature enhancement of the added first and second motion features to generate the current level motion feature.

For some embodiments of the first example method, adding the first and the second motion features includes concatenating the first and the second motion features.

For some embodiments of the first example method, generating the predicted feature based on the shifted reference frame feature and the second motion feature includes: concatenating the shifted reference frame feature and the second motion feature to generate a concatenated feature; performing a feature extraction on the concatenated feature to generate an extracted feature; and pruning the extracted feature to generate the predicted feature.

For some embodiments of the first example method, determining the shifted reference frame feature based on the reference frame feature and the first motion feature includes: concatenating the reference frame feature and the first motion feature to generate a concatenated feature; performing a feature extraction on the concatenated feature to generate an extracted feature; and pruning the extracted feature to generate the shifted reference frame feature.

A first example apparatus in accordance with some embodiments may include: a processor; and a memory storing instructions operative, when executed by the processor, to cause the apparatus to: obtain a parent level motion feature; generate a first motion feature by upsampling the parent level motion feature; obtain a reference frame feature; determine a shifted reference frame feature based on the reference frame feature and the first motion feature; decode a second motion feature by obtaining a motion bitstream; generate a current level motion feature by adding the first and the second motion features; generate a predicted feature based on the shifted reference frame feature and the second motion feature; and decode an inter-predicted point cloud frame based on the predicted feature.

A second example method in accordance with some embodiments may include: obtaining a current frame feature; obtaining a parent level motion feature; generating a first motion feature by upsampling the parent level motion feature; obtaining a reference frame feature; determining a shifted reference frame feature based on the reference frame feature and the first motion feature; generating a second motion feature based on the current frame feature and the shifted reference frame feature; generating a current level motion feature by adding the first and the second motion features; generating a predicted feature based on the shifted reference frame feature and the second motion feature; encoding the second motion feature into a motion bitstream; and encoding an inter-predicted point cloud frame based on the predicted feature.

For some embodiments of the second example method, obtaining the current frame feature includes: obtaining a current frame point cloud; and performing a feature extraction on the current frame point cloud to generate the current frame feature.

For some embodiments of the second example method, obtaining the reference frame includes: obtaining a reference point cloud; and performing a feature extraction of the reference point cloud to generate the reference frame.

For some embodiments of the second example method, upsampling the parent level motion feature includes: unpooling the parent level motion feature; and pruning the unpooled parent level motion feature to generate the first motion feature.

For some embodiments of the second example method, pruning the unpooled parent level motion feature is based on a reference point cloud.

For some embodiments of the second example method, generating the current level motion feature includes: adding the first and the second motion features; and performing a feature enhancement of the added first and second motion features to generate the current level motion feature.

For some embodiments of the second example method, adding the first and the second motion features includes concatenating the first and the second motion features.

For some embodiments of the second example method, generating the predicted feature based on the shifted reference frame feature and the second motion feature includes: concatenating the shifted reference frame feature and the second motion feature to generate a concatenated feature; performing a feature extraction on the concatenated feature to generate an extracted feature; and pruning the extracted feature to generate the predicted feature.

For some embodiments of the second example method, determining the shifted reference frame feature based on the reference frame feature and the first motion feature includes: concatenating the reference frame feature and the first motion feature to generate a concatenated feature; performing a feature extraction on the concatenated feature to generate an extracted feature; and pruning the extracted feature to generate the shifted reference frame feature.

For some embodiments of the second example method, encoding the second motion feature into the motion bitstream includes: quantizing the second motion feature; and arithmetically encoding the quantized second motion feature to generate the motion bitstream.

One or more embodiments provide a computer program including instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods include one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present application may refer to “determining” various pieces of information. Determining information may include one or more of, for example, estimating, calculating, predicting, or retrieving (e.g., from memory) the information.

The present application may refer to “accessing” various pieces of information. Accessing information may include one or more of, for example, receiving, retrieving (e.g., from memory), storing, moving, copying, calculating, determining, predicting, or estimating the information. Similarly, the present application may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present application or the following claims. Although features and elements are described herein in particular combinations, those of ordinary skill in the art will appreciate that such features or elements may be used alone or in any combination with the other features and elements. It is understood, therefore, that the overall teachings of the present application are not limited to the particular embodiments, implementations, and examples disclosed herein, but are intended to cover variations, modifications, and alternatives as defined by the appended claims and any and all equivalents thereof.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various numeric values may be used in the present application, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAS), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A learning-based predictive point cloud decoding method, comprising:
obtaining a parent level motion feature;
generating a first motion feature by upsampling the parent level motion feature;
obtaining a reference frame feature;
determining a shifted reference frame feature based on the reference frame feature and the first motion feature;
decoding a second motion feature from a motion bitstream;
generating a current level motion feature by adding the first and the second motion features;
generating a predicted feature based on the shifted reference frame feature and the second motion feature; and
decoding an inter-predicted point cloud frame based on the predicted feature.

2. The method of claim 1, wherein decoding the second motion feature comprises:
obtaining the motion bitstream;
arithmetically decoding the motion bitstream; and
dequantizing the arithmetically decoded motion bitstream to generate the second motion feature.

3. The method of claim 1, wherein obtaining the reference frame comprises:
obtaining a reference point cloud; and
performing a feature extraction of the reference point cloud to generate the reference frame.

4. The method of claim 1, wherein upsampling the parent level motion feature comprises:
unpooling the parent level motion feature; and
pruning the unpooled parent level motion feature to generate the first motion feature.

5. The method of claim 4, wherein pruning the unpooled parent level motion feature is based on a reference point cloud.

6. The method of claim 1, wherein generating the current level motion feature comprises:
adding the first and the second motion features; and
performing a feature enhancement of the added first and second motion features to generate the current level motion feature.

7. The method of claim 1, wherein adding the first and the second motion features comprises concatenating the first and the second motion features.

8. The method of claim 1, wherein generating the predicted feature based on the shifted reference frame feature and the second motion feature comprises:
concatenating the shifted reference frame feature and the second motion feature to generate a concatenated feature;
performing a feature extraction on the concatenated feature to generate an extracted feature; and
pruning the extracted feature to generate the predicted feature.

9. The method of claim 1, wherein determining the shifted reference frame feature based on the reference frame feature and the first motion feature comprises:
concatenating the reference frame feature and the first motion feature to generate a concatenated feature;
performing a feature extraction on the concatenated feature to generate an extracted feature; and
pruning the extracted feature to generate the shifted reference frame feature.

10. An apparatus comprising:
a processor; and
a memory storing instructions operative, when executed by the processor, to cause the apparatus to:
obtain a parent level motion feature;
generate a first motion feature by upsampling the parent level motion feature;
obtain a reference frame feature;
determine a shifted reference frame feature based on the reference frame feature and the first motion feature;
decode a second motion feature by obtaining a motion bitstream;
generate a current level motion feature by adding the first and the second motion features;
generate a predicted feature based on the shifted reference frame feature and the second motion feature; and
decode an inter-predicted point cloud frame based on the predicted feature.

11. A learning-based predictive point cloud encoding method, comprising:
obtaining a current frame feature;
obtaining a parent level motion feature;
generating a first motion feature by upsampling the parent level motion feature;
obtaining a reference frame feature;
determining a shifted reference frame feature based on the reference frame feature and the first motion feature;
generating a second motion feature based on the current frame feature and the shifted reference frame feature;
generating a current level motion feature by adding the first and the second motion features;
generating a predicted feature based on the shifted reference frame feature and the second motion feature;
encoding the second motion feature into a motion bitstream; and
encoding an inter-predicted point cloud frame based on the predicted feature.

12. The method of claim 11, wherein obtaining the current frame feature comprises:
obtaining a current frame point cloud; and
performing a feature extraction on the current frame point cloud to generate the current frame feature.

13. The method of claim 11, wherein obtaining the reference frame comprises:
obtaining a reference point cloud; and
performing a feature extraction of the reference point cloud to generate the reference frame.

14. The method of claim 11, wherein upsampling the parent level motion feature comprises:
unpooling the parent level motion feature; and
pruning the unpooled parent level motion feature to generate the first motion feature.

15. The method of claim 14, wherein pruning the unpooled parent level motion feature is based on a reference point cloud.

16. The method of claim 11, wherein generating the current level motion feature comprises:
adding the first and the second motion features; and
performing a feature enhancement of the added first and second motion features to generate the current level motion feature.

17. The method of claim 11, wherein adding the first and the second motion features comprises concatenating the first and the second motion features.

18. The method of claim 11, wherein generating the predicted feature based on the shifted reference frame feature and the second motion feature comprises:
concatenating the shifted reference frame feature and the second motion feature to generate a concatenated feature;
performing a feature extraction on the concatenated feature to generate an extracted feature; and
pruning the extracted feature to generate the predicted feature.

19. The method of claim 11, wherein determining the shifted reference frame feature based on the reference frame feature and the first motion feature comprises:
concatenating the reference frame feature and the first motion feature to generate a concatenated feature;
performing a feature extraction on the concatenated feature to generate an extracted feature; and
pruning the extracted feature to generate the shifted reference frame feature.

20. The method of claim 1, wherein encoding the second motion feature into the motion bitstream comprises:
quantizing the second motion feature; and
arithmetically encoding the quantized second motion feature to generate the motion bitstream.
